(19) United States
(12) Patent Application Publication
(10) Pub. No.: US 2008/0032582 A1
(43) Pub. Date: Feb. 7, 2008

(54) Protective covering

(76) Inventor: Huey-Shen Wu, Newark, DE (US)

Correspondence Address: HUEY-SHEN WU, 25 HARRIS CIRCLE, NEWARK, DE, 19711, US

(21) Appl. No.: 11/500,071

(22) Filed: Aug. 7, 2006

(51) Int. Cl. B32B 5/26; B32B 27/12; B32B 27/36

(52) U.S. Cl. 442/394; 442/381; 442/395

(57) ABSTRACT

The present invention relates to flexible protective covering, comprising a composite sheet providing high level of both waterproof and moisture vapor permeability. In its first aspect, the composite sheet consists of at least a thin layer of non-woven fabric and at least a thin layer of air-impermeable, non-porous, hydrophilic polymer. In its second aspect, the composite sheet is further impregnated with at least another layer of hydrophilic polymer into the non-woven fabric side. In its third aspect, the composite sheet consists of a thin layer of air-impermeable, non-porous, hydrophilic polymers comprising poly(amic acid) or polyetherpoly(amic acid) or polyetherpolyimide and at least a porous substrate.

### FIELD OF THE INVENTION

This invention relates to flexible protective covering made from composite sheets which are particularly suited for use of liquid resistant, waterproof, and moisture vapor permeable textile materials, or apparel made from the materials.

### BACKGROUND OF THE INVENTION

Materials for protective covering such as rainwear are known having a layer of expanded microporous polytetrafluoroethylene or microporous polypropylene, which are liquid resistant yet moisture vapor permeable. For example, Gore, U.S. Pat. No. 3,953,566 teaches a process of making expanded microporous polytetrafluoroethylene. However, the porous material can be contaminated by sweat or oil and loses waterproof. Therefore, Gore, et al., U.S. Pat. No. 4,194,041 teaches the use of additional coating on microporous membranes based on polyetherpolyurethane or polyperfluorosulfonic acid. However, recent announcement by U.S. Environmental Protection Agency (EPA) reveals that a chemical called perfluoro octanoic acid (C8) used to make polytetrafluoroethylene has been found to be potential human carcinogen. Major global manufactures have agreed to phase out of C8 by year 2016. This prompts urgent need to find alternative membrane materials other than polytetrafluoroethylene.

Polyetherpolyurethane has been found an alternative membrane material for making liquid resistant, moisture vapor permeable membranes. For example, Henn, U.S. Pat. No. 4,532,316 teaches the use of hydrophilic polyetherpolyurethane. However, in order to achieve high liquid resistant membrane, much thicker membrane is required, which causes lower in moisture vapor permeability. Traditionally, a use of tricot knit adhered to the membrane material has also been found to increase membrane liquid resistance; however, it causes significant reduction in moisture vapor permeability. Other teachings suggesting the use of other membrane materials such as polyetherpolyester or polyetherpolyamide have all suffered from the same disadvantage. U.S. Pat. No. 5,824,405 teaches the use of porous polyimide film, but such porous polyimide film is too stiff, not suitable for flexible textile application and can also be contaminated for oil or sweat and lose waterproof.

### SUMMARY OF THE INVENTION

It is the purpose of this invention to provide air-impermeable composite sheets that have both high liquid resistance (waterproof holding water pressure at least 1 bar) and high moisture vapor permeability (greater than 3,000 gram water/m²/day) without polytetrafluoroethylene.

In its first embodiment of this invention, the composite sheet is made by adhering
(A) At least a thin layer of non-woven fabrics made of polyamide, polyester, or poly(phenylene sulfide) that has thickness less than 240 micrometer and weight less than 60 gram/m² and filament denier number less than 20.
(B) At least a thin layer of air-impermeable, non-porous, hydrophilic polymer that has thickness less than 50 micrometer and weight less than 60 gram/m² and moisture vapor permeability greater than 3,000 grams/m²/day.

Preferably, the two layers are adhered together by impregnating (B) onto (A), partially or fully, although lamination of the two layers by adhesives can also be done.

In another preferred embodiment, the thin layer of non-woven polyamide or polyester or poly(phenylene sulfide) of (A) is made by spinning and autogenously bonding or thermally bonding continuous filaments of polyamide or polyester or poly(phenylene sulfide) into a flat, smooth, strong fabric. Autogenously bonding is achieved by exposing the polyamide or polyester or poly(phenylene sulfide) web to a chemically activating gas phase that is later removed from the web. The said thin layer of non-woven is made of said polymer filaments with denier number less than 20, preferably less than 10, most preferably less than 5. Denier number is defined as the number of grams per 9000 meters. The most preferred material is non-woven Nylon 6, 6 fabrics made by spinning and autogenously or thermally bonding filaments of Nylon 6, 6. The thin layer of non-woven fabric is preferably having thickness less than 160 micrometer, most preferably less than 100 micrometer, and weight preferably less than 40 gram/m² and most preferably less than 25 gram/m². Poly(phenylene sulfide) (PPS) is preferred when flame resistant property is desired.

In another preferred embodiment, the thin layer of air-impermeable polymer of (B) is selected from polyetherpolyester, polyetherpolyamide, and polyetherpolyurethane. The said thin layer of air-impermeable polymer has thickness preferably less than 40 micrometer, most preferably less than 30 micrometer and weight preferably less than 48 gram/m², most preferably less than 36 gram/m², and moisture vapor permeability preferably greater than 4,000 grams/m²/day, most preferably greater than 5,000 grams/m²/day.

In its second embodiment of this invention, the composite sheet of first embodiment of this invention is further improved by additionally coated with at least one layer of hydrophilic polymers selected from polyetherpolyester, polyetherpolyamide, polyetherpolyurethane, polyether-melamine-formaldehyde, polyether-urea-formaldehyde, polyetherpolyimide, polyetherpolyamic acid, polyacrylics, polyacrylamides, poly(alkylene/maleic acid), other polymers containing maleic acid or maleic anhydride, poly(amic acid), poly(alkylenimine), poly(vinylamine), and poly(vinyl alcohol). It is preferred that the hydrophilic polymers are coated on the side of porous polyamide or polyester or poly(phenylene sulfide) layer (A) of the composite sheet. The side of porous polyamide or polyester or poly(phenylene sulfide) is partially or fully impregnated by the selected hydrophilic polymers. The coating weight of the hydrophilic polymers is in the range of 1 to 80 gram/m², preferably in the range of 5 to 50 gram/m², and most preferably in the range of 10 to 30 gram/m².

In its third embodiment of this invention, the composite sheet is made by impregnating, fully or partially, or laminating by adhesives a layer of porous substrate with a very unique thin layer of continuous, air-impermeable, hydrophilic polymers containing poly(amic acid) or polyetherpoly(amic acid) or polyetherpolyimide. The porous substrate can be any woven or non-woven fabric or porous membranes including porous polyamide, porous polyphenylene sulfide, microporous polytetrafluoroethylene and microporous polypropylene. It is preferred that the porous substrate is pre-treated with hydrophobic and oleophobic materials that enhance substrates hydrophobicity and oleophobicity prior to adherence with the thin layer of hydrophilic polymers containing poly(amic acid) or polyetherpoly(amic acid) or polyetherpolyimide.

### DETAILED DESCRIPTION OF THE INVENTION

The flexible protective covering is pliable, air-impermeable, liquid resistant, with waterproof at least water pressure of 1 bar and with moisture vapor permeability greater than 3,000 gram/m²/day. Air-impermeable means no airflow is observed for at least two minutes as determined by the Gurley test described later.

The flexible protective covering consists of a composite sheet made by adhering
(A) at least a thin layer of non-woven fabric made of polyamide, polyester, or poly(phenylene sulfide) having thickness less than 240 micrometer and weight less than 60 gram per square meter and filament denier number less than 20.
(B) At least a thin layer of air-impermeable, non-porous, hydrophilic polymer, having thickness less than 50 micrometer and weight less than 60 gram/m² and moisture vapor permeability greater than 3,000 grams/m²/day.

Adhering means layer to layer surface contact or impregnation, fully or partially, of layer (B) into the pores of layer (A), as well as adherence by use of an adhesive.

In a preferred embodiment, the thin layer of non-woven of (A) is made by spinning and autogenously bonding or thermally bonding continuous filaments of polyamide or polyester or poly(phenylene sulfide) into a flat, smooth, strong fabric. Autogenously bonding is achieved by exposing the polyamide or polyester or poly(phenylene sulfide) web to a chemically activating gas phase that is later removed from the web. The said thin layer of non-woven is made of said polymer filaments with denier number less than 20, preferably less than 10, most preferably less than 5. Denier number is defined as the number of grams per 9000 meters. The most preferred polyamide is Nylon 6, 6, a condensation reaction product of hexamethylenediamine and adipic acid. Nylon 6, 6 is preferred because of its commercial availability, strong mechanical strength and high melting stability. The most preferred polyester is PET made by spinning, wet-laid, thermally bonding and calendering filaments of PET. PET is a condensation reaction product of ethylene glycol and terephathalic acid. PET is preferred because of its commercial availability, good mechanical strength and excellent melting stability. The most preferred non-woven PPS is made by spinning, wet-laid, thermally bonding and calendering filaments of PPS. PPS is preferred because of its commercial availability, good mechanical strength and excellent flame resistant property. Many companies have capability of making such non-woven fabrics, including but not limited to 3M and Kimberly-Clark. The thin layer of non-woven polyamide or polyester or polyphenylene sulfide is preferably having thickness less than 160 micrometer, most preferably less than 100 micrometer, and weight preferably less than 40 gram/m² and most preferably less than 25 gram/m².

In another preferred embodiment, the thin layer of air-impermeable polymer of (B) is selected from polyetherpolyester, polyetherpolyamide, and polyetherpolyurethane. Many companies offer such thin layer of polymers. For examples, DuPont offers excellent polyetherpolyester thin films, and Omniflex (Greenfield, Mass. 01302) offers polyetherpolyamide and polyetherpolyurethane thin films. The said thin layer of air-impermeable polymer has thickness preferably less than 40 micrometer, most preferably less than 30 micrometer, and weight preferably less than 48 gram/m², most preferably less than 36 gram/m², and moisture vapor permeability preferably greater than 4,000 grams/m²/day, most preferably greater than 5,000 grams/m²/day.

In its second embodiment of this invention, the composite sheet of the first embodiment of this invention is further improved by additionally coated with at least one layer of hydrophilic polymers selected from polyetherpolyester, polyetherpolyamide, polyetherpolyurethane, polyether-melamine-formaldehyde, polyether-urea-formaldehyde, polyetherpolyimide, polyetherpoly(amic acid), polyacrylics, polyacrylamides, poly(alkylene/maleic acid), other polymers containing maleic acid or maleic anhydride and polymers derived from, poly(amic acid), poly(alkylenimine), poly(vinylamine), copolymers or homopolymers of poly(vinyl alcohol), celluloses. It is preferred that the hydrophilic polymers are coated on the side of porous polyamide or polyester or polyphenylene sulfide layer (A) of the composite sheet. The side of porous polyamide or polyester or polyphenylene sulfide is partially or fully impregnated by the selected hydrophilic polymers. The coating weight of the hydrophilic polymers is in the range of 1 to 80 gram/m², preferably in the range of 5 to 50 gram/m², most preferably in the range of 10 to 30 gram/m².

The said polyetherpolyester is usually referred to as condensation reaction product of at least a polyethylene glycol (Mw. in the range of 600 to 3500), at least a diacid such as terephathalic acid, and a glycol such as ethylene glycol. The weight ratio of polyethylene glycol is preferred to be in the range of 45-75% by weight of the hydrophilic polyetherpolyester.

The said polyetherpolyamide is usually referred to as condensation reaction product of at least an aliphatic polyether diamine (Mw. in the range of 600 to 3500), at least a diacid such as terephathalic acid, and an aromatic diamine, such as phenylene diamine. The weight ratio of aliphatic polyether diamine is preferred to be in the range of 45-75% by weight of the hydrophilic polyetherpolyamide.

The said hydrophilic polyetherpolyurethane has been well taught in U.S. Pat. Nos. 4,532,316, and 4,969,998, and many others.

The said polyether-melamine-formaldehyde or polyether-urea-formaldehyde is usually referred to as condensation reaction product of polyethylene glycol (Mw. In the range of 600 to 3500), with a melamine formaldehyde resin or a urea formaldehyde resin. The weight ratio of polyethylene glycol is preferred to be in the range of 45-75% by weight of the hydrophilic polyether-melamine formaldehyde.

The said polyetherpoly(amic acid) is defined to be reaction product of at least an aliphatic polyether diamine (Mw. in the range of 600 to 3500), at least a dianhydride, such as pyromellitic dianhydride, and a diamine (Mw. Less than 600), such as phenylene diamine. Polyetherpolyimide can then be made by additional thermal or chemical imidization process from its precursor polyetherpoly(amic acid). The weight ratio of aliphatic polyether diamine is preferred to be in the range of 45-75% by weight of both hydrophilic polymers. Both polyetherpoly(amic acid) and polyetherpolyimide are preferred because of their exceptionally superior mechanical strength compared to other polyetherpolymers.

The hydrophilic polyacrylics are usually referred to as free radical polymerization products of alkyl(meth)acrylates and (meth)acrylic acid, wherein hydrophobic alkyl(meth)acrylates provide mechanical strength, while (meth)acrylic acid provides hydrophilicity for adequate moisture vapor permeability.

The hydrophilic polacrylamides are usually referred to as free radical polymerization products of alkyl(meth)acrylamides and (meth)acrylamides, wherein hydrophobic alkyl(meth)acrylamides provide mechanical strength, while other hydrophilic meth(acrylamides provides hydrophilicity for adequate moisture vapor permeability.

The hydrophilic polymers containing maleic acid or maleic anhydride and polymers derived from are usually referred to as free radical polymerization products of maleic acid or maleic anhydride with at least one electronic donating monomer such as styrene, alkyl vinyl ether, vinyl acetate, vinyl formate, ethylene, propylene, butylenes, isobutylene and the like. The hydrophilic polymers can be further derived by neutralization with a base, such as metal hydroxide or amines.

Poly(amic acid) is generally defined as a reaction product of at least one dianhydride and at least one diamine in about equal molar ratio in a dipolar aprotic solvent such as dimethylformaldehyde, dimethylacetamide, or M-methylpyrrolidinone. Aromatic dianhydride and aromatic diamine are preferred, but aliphatic dianhydrides and aliphatic diamines can also be used. Examples for aromatic dianhydride include benzophenone-3,3′,4,4′,-tetracarboxylic dianhydride, pyromellitic dianhydride, biphenyl tetracarboxylic dianhydride, oxybiphenyl tetracarboxylic dianhydride. Examples for aliphatic dianhydride include cyclobutane tatracarboxylic anhydride. Examples for aromatic diamine include 1,4-phenylene diamine, 1,3-phenylene diamine, 4,4′-oxydianiline. Examples for aliphatic diamine include alkylene (C2-C12) diamine, piperazine, aliphatic polyether diamine (molecular weight from 100 to 3500). Like polyimides, poly(amic acid) has similar superior mechanical and thermal capacity outperform any known man-made polymers. The poly(amic acid) can provide good moisture vapor permeability especially when the acid group is further neutralized by a base such as metallic hydroxides, including but no limited to sodium hydroxide or potassium hydroxide or amines, including but not limited to tributylamine, ethanolamine, diethanolamine, or triethanolamine.

Polyalkylenimine is usually referred to as polyamines wherein amines are connected by alkylene group ranging from C2-C6. Examples include polyethylenimine and polypropylenimine. Crosslinking of polyalkylenimine is preferred in the finishing coating.

In its third embodiment of this invention, the composite sheet is made simply by impregnating, fully or partially, or laminating by adhesives a porous substrate with at least a very unique layer of continuous, air-impermeable, hydrophilic polymers containing poly(amic acid) or polyetherpoly(amic acid) or polyetherpolyimide defined above. The porous substrate can be any woven or non-woven fabric or porous membranes including porous polyamide, porous polyphenylene sulfide, microporous polytetrafluoroethylene and microporous polypropylene. It is preferred that the porous substrate is pre-treated with hydrophobic and oleophobic materials that render substrates hydrophobicity and oleophobicity prior to adherence with the layer of hydrophilic polymers containing poly(amic acid) or polyetherpoly(amic acid) or polyetherpolyimide. Oil repellent rating of the porous substrate is preferred to be greater than 2.

The hydrophilic polymers containing poly(amic acid) or polyetherpoly(amic acid) or polyetherpolyimide are most preferred polymers due to their superior mechanical properties, outstanding thermal stability and high moisture vapor permeability. Preferred poly(amic acid) includes those containing aromatic functional group. Polyetherpoly(amic acid) can be converted to polyetherpolyimide via additional thermal or chemical imidization process, wherein hydrophilic polyether of polyetherimide can still offer good moisture vapor permeability. The layer of hydrophilic polymers containing poly(amic acid) or polyetherpoly(amic acid) or polyetherpolyimide should be less than 80 gram/m², preferably less than 60 gram/m², most preferably less than 40 gram/m².

### Test Methods

Air Permeability/Impermeability-Gurley Number Test

Curley numbers were obtained as follows:

The resistance of samples to air flow was measured by a Gurley densometer (ASTM D726-58) manufactured by W. & L. E. Gurley & Sons. The results are reported in terms of Gurley Number which is the time in seconds for 100 cubic centimeters of air to pass through 6.54 cm² of a test sample at a pressure drop of 1.215 kN/m² of water. A material is air-impermeable if no air is observed over 120 second interval.

Moisture Vapor Permeability Test: (ASTM-E96-66BW)

As described by ASTM-E96-66BW test method, the cup is inverted for the test. The sample with face fabric side is facing the water. The data are reported in the unit of gram of water permeated/m²/day.

Waterproof Test

The Mullins Burst Test (Fed. Std. 191, Method 5512) was used. The test method has been described in details also in U.S. Pat. No. 4,194,041. A test pressure level of 1.72 Bar was used by the U.S. Army as an acceptable level of waterproof for rainwear garments.

Oil Repellent Test

AATCC Test Method 118-1983 was used, wherein an oil repellent rating is given from 1 to 8. Higher oil rating means better oil repellency.

### EXAMPLE 1

First a composite sheet was made by a thin layer of hydrophilic polyetherpolyurethane impregnated into a thin layer of Nylon 6, 6 non-woven fabric. A thin layer of hydrophilic, air-impermeable, non-porous polyetherpolyurethane with thickness about 25 micrometer, weight about 30 gram/m² and moisture vapor permeability greater than 5,000 gram/m²/day obtained from Omniflex (Greenfield, Mass. 01301, USA) was used. The polyetherpolyurethane is a thermoplastic elastomer with a melting point about 190° C. A thin layer of Nylon 6, 6 non-woven fabric with thickness about 80 micrometer, weight about 17 gram/m², porosity about 80%, burst strength (ASTM D-3786-87) about 1.1 bar, was used. The thin layer of Nylon 6, 6 non-woven fabric was made by spunbond process via melt spinning and autogenously bonding continuous filaments of Nylon 6, 6 with denier number of about 4 into a flat, smooth, strong fabric. The thin layer of polyetherpolyurethane was layered on top of the thin layer of Nylon 6, 6 non-woven fabric. Then, both layers were clamped and placed in a hot air-circulated oven at 200 C for 1 minute. The thin layer of polyetherpolyurethane was melted and impregnated into the thin layer of Nylon 6, 6 non-woven fabric. After the layered materials were removed from the oven, both layers are found adhered together into a smooth, flexible composite sheet. The composite sheet surprisingly has much greater mechanical strength than each individual layer. This can be evident by the test that a finger nail cannot poke a hole through the composite layer, while each individual layer can be punctured by a finger nail. The moisture vapor permeability of the composite sheet has surprisingly greater than 5,000 gram/m²/day. The composite sheet was found pass waterproof test at 1 bar water pressure.

Additionally, the composite sheet was spotwise adhered to a Nylon Taffeta fabric, 75 gram/m². The lamination process was similar to the method taught in Example 6 of U.S. Pat. No. 4,532,316. The air-impermeable polyetherpolyurethane layer side faced the Nylon Taffeta fabric. The moisture vapor permeability of the fabric composite remains surprisingly greater than 5,000 gram/m²/day. Not only the thin layer of non-woven fabric serves as a protective layer strengthening the thin layer of hydrophilic, air-impermeable, non-porous polyetherpolyurethane but most surprisingly the thin layer of non-woven fabric does not create any significant resistance to moisture vapor permeability. If the thin layer of non-woven fabric is replaced by a tricot knit, a significant reduction in moisture vapor permeability was observed, which is undesirable.

### EXAMPLE 2

A composite sheet made by a thin layer of hydrophilic polyetherpolyamide impregnated into a thin layer of PET non-woven fabric: A thin layer of hydrophilic, air-impermeable, non-porous polyetherpolyamide with thickness about 30 micrometer, weight about 33 gram/m² and moisture vapor permeability greater than 4,000 gram/m²/day obtained from Omniflex (Greenfield, Mass. 01301, USA) was used. The polyetherpolyamide is a thermoplastic elastomer with a melting point about 160° C. A thin layer of PET non-woven fabric with thickness about 100 micrometer, weight about 60 gram/m², density about 0.59, burst strength (ASTM D-3786-87) about 3.9 bar, was used. The thin layer of PET non-woven fabric was made by spunbond process via melt spinning and thermally bonding continuous filaments of PET into a flat, smooth, strong fabric. The thin layer of polyetherpolyamide was layered on top of the thin layer of PET non-woven fabric. Then, both layers were clamped and placed in a hot air-circulated oven at 170° C. for 1 minute. The thin layer of polyetherpolyamide was melted and impregnated into the thin layer of PET non-woven fabric. After the layered materials were removed from the oven, both layers are found adhered together into a smooth, flexible composite sheet. The composite sheet surprisingly has much greater mechanical strength than each individual layer. This can be evident by the test that a finger nail cannot poke a hole through the composite layer, while polyetherpolyamide layer alone can be punctured by a finger nail. The moisture vapor permeability of the composite sheet has surprisingly greater than 4,000 gram/m²/day. The composite sheet was found pass waterproof test at 1 bar water pressure.

Similar to Example 1, the composite sheet was spotwise adhered to a polyester fabric, 70 gram/m². The air-impermeable polyetherpolyamide layer side faced the polyester fabric. The moisture vapor permeability of the fabric composite remains surprisingly greater than 4,000 gram/m²/day.

### COMPARATIVE EXAMPLE 2

The example 2 was repeated except that the thin layer of PET non-woven fabric was replaced by a Nylon tricot knit with the same weight/m². The tricot knit was spot-wise adhered to the polyetherpolyamide layer by adhesive. The moisture vapor permeability of the final three layer fabric composite drops to about 3,000 gram/m²/day, which is not desirable. This demonstrates the advantage of using the thin layer of non-woven fabric described in this invention over the use of traditional tricot knit. The results are surprising and the reason is not yet fully understood.

### EXAMPLE 3

A composite sheet made by a thin layer of hydrophilic polyetherpolyester impregnated into a thin layer of PPS non-woven fabric: A thin layer of hydrophilic, air-impermeable, non-porous polyetherpolyester with thickness about 20 micrometer, weight about 24 gram/m² and moisture vapor permeability greater than 3,000 gram/m²/day obtained from Omniflex (Greenfield, Mass. 01301, USA) was used. The polyetherpolyester is a thermoplastic elastomer with a melting point about 200° C. A thin layer of PPS non-woven fabric with thickness about 86 micrometer, weight about 40 gram/m², density about 0.47, burst strength (ASTM D-3786-87) about 0.5 bar, was used. The thin layer of PPS non-woven fabric was made by spunbond process via melt spinning and thermally bonding continuous filaments of PPS into a flat, smooth, strong fabric. The thin layer of polyetherpolyester was layered on top of the thin layer of PPS non-woven fabric. Then, both layers were clamped and placed in a hot air-circulated oven at 215° C. for 1 minute. The thin layer of polyetherpolyester was melted and impregnated into the thin layer of PPS non-woven fabric. After the layered materials were removed from the oven, both layers are found adhered together into a smooth, flexible composite sheet. The composite sheet surprisingly has much greater mechanical strength than each individual layer. This can be evident by the test that a finger nail cannot poke a hole through the composite layer, while polyetherpolyester layer alone can be punctured by a finger nail. The moisture vapor permeability of the composite sheet has surprisingly greater than 3,000 gram/m²/day. The composite sheet was found pass waterproof test at 1 bar water pressure.

Similar to Example 1, the composite sheet was spotwise adhered but to a Nomex® fabric (flame resistant fabric, from DuPont, USA). The air-impermeable polyetherpolyester layer side faced the Nomex fabric. The moisture vapor permeability of the fabric composite remains surprisingly greater than 3,000 gram/m²/day.

### EXAMPLE 4

### Synthesis of PolyetherPoly(Amic Acid)

3.74 gram of aliphatic polyether diamine derived from a propylene oxide-capped polyethylene glycol (average Mw. 950, obtained from Huntsman, Tex., USA, Trade name XTJ-501)+11.43 gram of aliphatic polyether diamine derived from a propylene oxide-capped polyethylene glycol (average Mw. 2000, obtained from Huntsman, Tex., USA, Trade name XTJ-502) were heated to 150° C. for 30 minutes under slight vacuum to remove residual moisture. The mixture was allowed to cool to 50° C. To the mixture, 20 gram of Dimethylformamide (anhydrous, obtained from Aldrich Chemical) was added under agitation, following by addition of 3.4 gram of Benzophenone-3,3′, 4,4′-tetracarboxylic dianhydride (obtained from Aldrich Chemical) with agitation. Reaction took place immediately with heat generated. The reaction was continued for 30 minutes. Then, to the mixture, 1.08 gram of 1,3-phenylenediamine (obtained from Aldrich Chemical) was added under agitation, following by additional 3.3 gram of Benzophenone-3,3′, 4,4′-tetracarboxylic dianhydride (obtained from Aldrich Chemical) adding to the mixture. The mixture became quite viscous. The agitation was continued at ambient condition for 12 hours. A brown polyetherpoly(amic acid) solution was formed.

(Mix 4A) Half of the resulting polyetherpoly(amic acid) solution was added with 20 gram of de-ionized water and 1.18 gram of potassium hydroxide (Aldrich). After thorough agitation, the mixture became thinner in viscosity and the polymer became polyetherpoly(amic acid/potassium salt).

(Mix 4B) Half of the resulting polyetherpoly(amic acid) solution was added with 20 gram of de-ionized water and 2.18 gram of diethanolamine (DEA, Huntsman). After thorough agitation, the mixture became thinner in viscosity and the polymer became polyetherpoly(amic acid/DEA salt).

### EXAMPLE 5

### Synthesis of Poly(Amic Acid)

To 35 gram of Dimethylformamide (anhydrous, obtained from Aldrich Chemical) was added 3.24 gram of 1,3-phenylenediamine (obtained from Aldrich Chemical) under agitation, following by addition of 6.7 gram of Pyromellitic Dianhydride (obtained from Aldrich Chemical) with agitation. Reaction took place immediately with heat generated. The reaction was continued for 12 hours. A poly(amic acid) solution was formed.

(Mix 5A) Half of the poly(amic acid) solution then was added with 5 gram of de-ionized water and 1.75 gram of potassium hydroxide (Aldrich). After thorough agitation, the mixture became thinner in viscosity and the polymer became poly(amic acid/potassium salt).

(Mix 5B) Half of the poly(amic acid) solution then was added with 5 gram of de-ionized water and 4.57 gram of triethanolamine (TEA, Huntsman). After thorough agitation, the mixture became thinner in viscosity and the polymer became poly(amic acid/TEA salt).

### EXAMPLE 6

### Coating Experiments Using PolyetherPoly(Amic Acid)

Mix 4A and Mix 4B were used to coat respectively the composite sheets made from Example 1. The coating was made by simple casting of the polyetherpoly(amic acid/potassium salt) solution or polyetherpoly(amic acid/DEA) solution on the Nylon 6, 6 non-woven fabric side of the composite sheet. The non-woven fabric was essentially saturated by the coating solution and excess fluid was wiped out by a wooden knife. The coated samples were then placed in a hot air-circulated oven at 180° C. for 5 minutes. The coated dried composite sheets remain very flexible. The coating weight of the polyetherpoly(amic acid) was estimated to be about 40 gram/m². The moisture vapor permeability of both the coated composite sheets was surprisingly still greater than 5,000 gram/m²/day. The coated composite sheets were found pass waterproof test at 1.72 bar water pressure, meeting US Army waterproof standard for rainwear garment.

### EXAMPLE 7

### Coating Experiments Using Poly(Amic Acid)

Mix 5A and Mix 5B were used to coat respectively the composite sheets made from Example 3. The coating was made by simple casting of the poly(amic acid/potassium salt) solution or poly(amic acid/DEA) solution on the PPS non-woven fabric side of the composite sheet. The non-woven fabric was essentially saturated by the solution and excess fluid was wiped out by a wooden knife. The coated samples were then placed in a hot air-circulated oven at 180° C. for 5 minutes. The coated dried composite sheets remain flexible. The coating weight of the poly(amic acid) was estimated to be about 30 gram/m². The moisture vapor permeability of both the coated composite sheets was surprisingly still greater than 3,000 gram/m²/day. The coated composite sheets were found pass waterproof test at 1.72 bar water pressure, meeting US Army waterproof standard for rainwear garment. The coated composite sheets are expected to have good flame resistant property contributed by Nomex, PPS and Poly(amic acid).

### EXAMPLE 8

### Coating Experiments on Oleophobic Porous Substrate

Mix 4A and Mix 4B were used to coat respectively a Nylon Taffeta fabric which weighs about 75 gram/m² and has water and oil repellent treatment wherein water repellency was 100 and oil repellency was 5 (AATCC Test Method 118-1983) layered with the same Nylon 6, 6 non-woven fabric used in Example 1. The Nylon 6, 6 non-woven fabric was layered on top of the oil repellent treated Nylon Taffeta fabric. The coating was made by simple casting of the polyetherpoly(amic acid/potassium salt) solution or polyetherpoly(amic acid/DEA) solution on top of the Nylon 6, 6 non-woven fabric. The non-woven fabric was essentially saturated by the solution and excess fluid on top was wiped out by a wooden knife. The coated samples were then placed in a hot air-circulated oven at 180° C. for 10 minutes. The coated dried composite fabrics remain very flexible. The same coating procedure was done twice on the same fabric layers to ensure waterproof. The coating weight of the polyetherpoly(amic acid) was estimated to be about 50 gram/m². The moisture vapor permeability of both the coated composite fabrics was greater than 4,000 gram/m²/day. The coated composite sheets were found pass waterproof test at 1 bar water pressure.

### EXAMPLE 9

### Coating Experiment

A mixture containing 35% by weight of polyethylene glycol (Mw. 1000, Fisher Scientific)+15% by weight of a melamine formaldehyde resin (Cytec Industries) with remaining being water was used to coat the composite sheet made from Example 1. The coating was made by simple casting of the polyether-melamine-formaldehyde solution on the Nylon 6, 6 non-woven fabric side of the composite sheet. The non-woven fabric was essentially saturated by the coating solution and excess fluid was wiped out by a wooden knife. The coated sample was then placed in a hot air-circulated oven at 170° C. for 5 minutes. The coated dried composite sheet remained very flexible. The moisture vapor permeability of the coated composite sheet has surprisingly still greater than 5,000 gram/m²/day. The coated composite sheet was found pass waterproof test at 1.72 bar water pressure, meeting US Army waterproof standard for rainwear garment.

### EXAMPLE 10

### Coating Experiment

A mixture containing 15% by weight of poly(styrene/maleic anhydride, obtained from Hercules, USA) fully neutralized by ammonia and potassium hydroxide (1:1 molar ratio) with remaining being water was used to coat the composite sheet made from Example 1. The coating was made by simple casting of the poly(styrene/maleic acid, potassium salt) solution on the Nylon 6, 6 non-woven fabric side of the composite sheet. The non-woven fabric was essentially saturated by the coating solution and excess fluid was wiped out by a wooden knife. The coated sample was then placed in a hot air-circulated oven at 170° C. for 5 minutes. The coated dried composite sheet remained flexible. The moisture vapor permeability of the coated composite sheet has surprisingly still greater than 5,000 gram/m²/day. The coated composite sheet was found pass waterproof test at 1.72 bar water pressure, meeting US Army waterproof standard for rainwear garment.

### EXAMPLE 11

### Coating Experiment

A mixture containing 25% by weight of poly(styrene/acrylic acid, obtained from Rohm & Haas, USA) fully neutralized by ammonia and potassium hydroxide (in 1:5 molar ratio) with remaining being water was used to coat the composite sheet made from Example 1. The coating was made by simple casting of the poly(styrene/acrylic acid, potassium salt) solution on the Nylon 6, 6 non-woven fabric side of the composite sheet. The non-woven fabric was essentially saturated by the coating solution and excess fluid was wiped out by a wooden knife. The coated sample was then placed in a hot air-circulated oven at 180° C. for 5 minutes. The coated dried composite sheet remained flexible. The moisture vapor permeability of the coated composite sheet has surprisingly still greater than 5,000 gram/m²/day. The coated composite sheet was found pass waterproof test at 1.72 bar water pressure, meeting US Army waterproof standard for rainwear garment.

We claim:

1. A composite sheet having waterproof greater than 1 bar water pressure and moisture vapor permeability greater than 3,000 grams/m²/day, comprising.
(A) At least a thin layer of non-woven fabric made of polyamide, polyester, or poly(phenylene sulfide), having thickness less than 240 micrometer and weight less than 60 gram/m² and filament denier number less than 20.
(B) At least a thin layer of air-impermeable, non-porous, hydrophilic polymer that has thickness less than 50 micrometer and weight less than 60 gram/m² and moisture vapor permeability greater than 3,000 grams/m²/day.

2. The composite sheet of claim 1 laminated to another textile, woven or non-woven fabric.

3. The composite sheet of claim 1 wherein layer (A) non-woven fabric has thickness less than 160 micrometer, and weight less than 40 gram/m² and filament denier number less than 10.

4. The composite sheet of claim 1 wherein layer (A) non-woven fabric has thickness less than 100 micrometer, and weight less than 25 gram/m² and filament denier number less than 5.

5. The composite sheet of claim 1 wherein layer (B) hydrophilic polymer is selected from polyetherpolyester, polyetherpolyamide, and polyetherpolyurethane.

6. The composite sheet of claim 1 wherein layer (B) has thickness less than 40 micrometer, and weight less than 48 gram/m², and moisture vapor permeability greater than 4,000 grams/m²/day.

7. The composite sheet of claim 1 wherein layer (B) has thickness less than 30 micrometer and weight less than 36 gram/m², and moisture vapor permeability greater than 5,000 grams/m²/day.

8. A composite sheet having waterproof greater than 1 bar water pressure and moisture vapor permeability greater than 3,000 grams/m²/day, comprising:
(A) at least a thin layer of non-woven fabric made of polyamide, polyester, or poly(phenylene sulfide), having thickness less than 240 micrometer and weight less than 60 gram/m² and filament denier number less than 20.
(B) At least a thin layer of air-impermeable, non-porous polymer, having thickness less than 50 micrometer and weight less than 60 gram/m² and moisture vapor permeability greater than 3,000 grams/m²/day.
(C) At least one thin layer of hydrophilic polymer impregnating layer (A), partially or fully, wherein the hydrophilic polymer is selected from polyetherpolyester, polyetherpolyamide, polyetherpolyurethane, polyether-melamine-formaldehyde, polyether-urea-formaldehyde, polyetherpolyimide, polyetherpolyamic acid, polyacrylics, polyacrylamides, poly(alkylene/maleic acid), other polymers containing maleic acid or maleic anhydride and polymers derived from, poly(amic acid), poly(alkylenimine), poly(vinylamine), copolymers or homopolymers of poly(vinyl alcohol), celluloses, and the weight of the hydrophilic polymer less than 80 gram/m².

9. The composite sheet of claim 8 laminated to another textile, woven or non-woven fabric.

10. The composite sheet of claim 8 wherein one layer of (C) in the range of 5 to 50 gram/m².

11. The composite sheet of claim 8 wherein one layer of (C) in the range of 10 to 30 gram/m².

12. The composite sheet of claim 8 wherein layer (B) polymer is selected from polyetherpolyester, polyetherpolyamide, and polyetherpolyurethane.

13. The composite sheet of claim 8 wherein layer (B) has thickness less than 40 micrometer, and weight less than 48 gram/m², and moisture vapor permeability greater than 4,000 grams/m²/day.

14. The composite sheet of claim 8 wherein layer (B) has thickness less than 30 micrometer and weight less than 36 gram/m², and moisture vapor permeability greater than 5,000 grams/m²/day.

15. A composite sheet having waterproof greater than 1 bar water pressure and moisture vapor permeability greater than 3,000 grams/m²/day, comprising:
(A) at least a layer of continuous, air-impermeable, non-porous, hydrophilic polymers containing poly(amic acid), polyetherpoly(amic acid) or polyetherpolyimide,
(B) at least a layer of porous substrate.

16. The composite sheet of claim 15 wherein layer of (A) containing poly(amic acid), a reaction product of at least a dianhydride and at least a diamine.

17. The composite sheet of claim 15 wherein layer of (A) containing poly(amic acid), a reaction product of at least a dianhydride selected from benzophenone-3,3′,4,4′-tetracarboxylic dianhydride, pyromellitic dianhydride, biphenyl tetracarboxylic dianhydride, oxybiphenyl tetracarboxylic dianhydride, cyclobutane tetracarboxylic dianhydride and at least a diamine selected from phenylene diamine, oxydianiline, alkylene (C2-C12) diamine, piperazine, aliphatic polyether diamine.

18. The composite sheet of claim 15 wherein layer of (A) containing poly(amic acid) neutralized, partially or fully, by a base including metallic hydroxide or an amine.

19. The composite sheet of claim 15 wherein layer of (B) porous substrate is woven fabric, non-woven fabric, knit, porous membranes, including porous polyamide, porous polyphenylene sulfide, microporous polytetrafluoroethylene and microporous polypropylene.

20. The composite sheet of claim 15 wherein layer of (B) porous substrate having water and oil repellent treatment, and oil rating greater than 2.
